(19) United States
(12) Patent Application Publication
(10) Pub. No.: US 2010/0179890 A1
(43) Pub. Date: Jul. 15, 2010

(54) TOOL INVENTORY MANAGEMENT SYSTEM

(76) Inventors: Michael S. Cianciotto, JR., Orlando, FL (US); Robert G. Miller, Titusville, FL (US); Richard Hal Craig, Cocoa, FL (US); Donald Lisi, Orange, FL (US)

Correspondence Address: Hayes Soloway P.C., 3450 E. Sunrise Drive, Suite 140, Tucson, AZ, 85718, US

(21) Appl. No.: 12/353,867

(22) Filed: Jan. 14, 2009

(51) Int. Cl. G06Q 10/00; G06K 7/00

(52) U.S. Cl. 705/28; 235/382

(57) ABSTRACT

An inventory management system and method for operating said system, wherein the system comprises an enclosure for containing a plurality of inventory items; a locking mechanism for preventing unauthorized access of the enclosure; and a computing system for controlling the locking mechanism and recording a transaction. The computing system further comprises a processor, a data storage unit, and a graphical user interface. The computing system logs information regarding the specific item, the location of use, and the date and time of the transaction. In a preferred embodiment, the inventory items are tools. The present disclosure discloses methods for operating the inventory management system, including methods for assigning a desired item to an authorized user; returning an item from a user to whom the item has been assigned; transferring an item from a first user to a second user; and taking inventory.

This disclosure described herein was made in part in the performance of work under NASA contract number NAS 10-02007 and is subject to the provisions of Section 305 of the National Aeronautics and Space Act of 1958 (72 Stat.435:42 U.S.C. 2457).

### FIELD

The present disclosure is generally related to a method and system for inventory management. The invention has particular utility for use with flight tool management systems and will be described in connection with such utility, although other utilities are contemplated.

### BACKGROUND

Companies typically have difficulties tracking inventory items or objects and their usage within their facilities. Many inventory items are misused, misplaced, and improperly tracked and replenished by the employees of the companies. In some industries, misplaced items can lead to increased costs and other problems.

For instance, a wrench or other tool left behind in the construction or maintenance of an engine could result in damage to the engine if undetected before operation Using a paper system, there was imperfect control over the toolboxes. Usually, boxes stayed open for the whole shift. A 3-ring binder remained on the top of the toolbox. Techs were required to check out a tool by filling out a log located in the binder on top of the toolbox, by hand. In the event of a lost tool, unreliable, often illegible records would have to be used to determine who the user might be. Often it was difficult to determine which user had gained access for any given shift. Inventories were taken pre-shift and post-shift. However, there was no way of knowing which tools were being used and how often and which tools had become obsolete. As a result a large inventory of tools was kept. This method required large amounts of time to manage inventory. In addition, large amounts of time and resources were consumed when a tool went missing.

Various systems have been proposed to address the problems described above. One such system provides for monitoring a controlled space wherein radio frequency identification (RFID) tags are attached to items within controlled space. A receiver is configured to receive signals from the RFID tag and send the signals to a computing device that verifies whether a user is authorized to be talking inventory from the controlled space. The computing device logs information regarding the user and associated inventory removed from the controlled space and stores this information in a database. The database may then be used to determine what user was last to check out an item of interest. See U.S. Pat. No. 7,337,963; and U.S. Patent Application No. 2007/0108273.

The RFID tags of the prior art systems are unacceptable for many applications because the tags are difficult or impractical for use with small items such as attachments for specific tools. Also, the RFID tags may become separated from tools. In addition, the prior art systems described above fail to provide reliable information regarding the location where a tool was last used.

Accordingly, there is a need for an improved tool inventory management system requiring minimal time, providing a reliable inventory mechanism, and wherein data regarding location of use for a tool is recorded.

### SUMMARY

The present disclosure addresses the needs outlined above by providing an inventory management system for conducting transactions and storing information related to each transaction, including the location where the tool will be used, who will be using the tool, and what time the transaction took place. The system and methods of the present disclosure accomplish these objectives without the use of radio frequency identification (RFID) tags associated with individual tools.

The inventory management system of the present disclosure includes a computing system that preferably incorporates a graphical user interface in the form of a touch screen. Audio is initiated when technician selects a task or any number of parameters, including location and the type of item. The methods of the present disclosure are conducted with minimal user input and is entirely paperless.

In a preferred embodiment, the system and methods of the present invention are used to operate a tool inventory management system using a Tool Report Access Program (TRAP). This software allows only authorized users to access the toolbox enclosure, sign out tools, and reduces the time for the user to sign out tools and keeps reliable logs for expedited tracking of tools.

One aspect of the present disclosure provides an inventory management system for tracking the use of inventory items, including an enclosure for containing a plurality of inventory items, a locking mechanism for preventing unauthorized access of the enclosure, and a computing system for controlling the locking mechanism and recording a transaction, wherein the computing system further comprises a processor, a data storage unit, and a graphical user interface.

Another aspect of the present disclosure provides a method for operating an inventory management system, including the steps of: placing at least one inventory item in at least one compartment within an enclosure, providing restricted access to the enclosure by use of a locking mechanism, and controlling the locking mechanism with a computing system comprising a processor, a data storage device, and a graphical user interface. In addition, access to the enclosure is restricted to authorized users that are identified by the computing system, and the method further includes at least one of the following steps:

(a) assigning a desired item to an authorized user, including prompting the user to input a location where the desired item will be used;

(b) returning an item from a user to whom the item has been assigned;

(c) transferring an item from a first user to whom an item has been assigned to a second user; and

(d) taking inventory of the items in the enclosure by using the graphical user interface to verify the actual inventory against transaction data recorded on the data storage device.

Other systems, methods, features, and advantages of the present disclosure will be or become apparent to one with skill in the art upon examination of the following drawings and detailed description. The features, functions and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a front view of an inventory management system, in accordance with one embodiment of the present disclosure;

FIG. 1B is a top view of a compartment of the inventory management system shown in FIG. 1A;

FIG. 2 is a flowchart demonstrating a method for acquiring an item from an inventory management system, in accordance with one embodiment of the present disclosure;

FIG. 3 is a flowchart demonstrating a method for acquiring an item from an inventory management system, in accordance with an alternative embodiment of the present disclosure;

FIG. 4 is a flowchart demonstrating a method for returning an item to an inventory management system, in accordance with the present disclosure;

FIG. 5 is a flowchart demonstrating a method for transferring an item to another user using an inventory management system in accordance with the present disclosure;

FIG. 6 is a flowchart demonstrating a method for taking inventory user using an inventory management system in accordance with the present disclosure;

FIG. 7 is a flowchart demonstrating a method for acquiring an item from an inventory management system, in accordance with another alternative embodiment of the present disclosure;

FIGS. 8-18 are illustrations of graphical user interface displays used in accordance with the present disclosure; and

FIG. 19 is a schematic view of an inventory management system in accordance with the present disclosure, networked with a central computer.

### DETAILED DESCRIPTION

In the following description, reference is made to the accompanying drawings, which form a part hereof, and in which is shown, by way of illustration, various embodiments of the present disclosure. It is understood that other embodiments may be utilized and changes may be made without departing from the scope of the present disclosure.

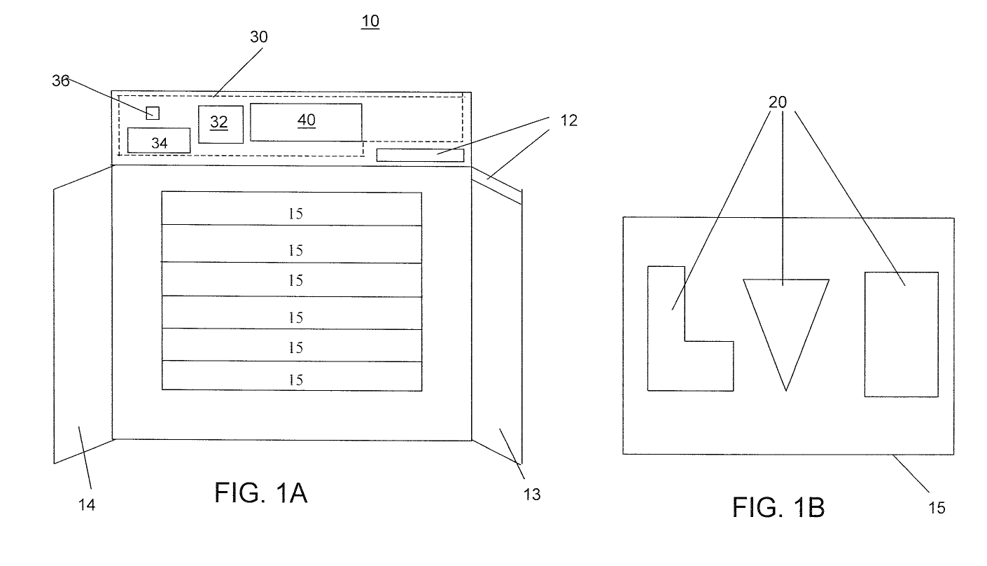

Referring to FIGS. 1A and 1B, the present disclosure provides an inventory management system, comprising: an enclosure 10, wherein the enclosure may further comprise a plurality of compartments 15, each of which may contain a plurality of inventory items 20; a locking mechanism 12 to control access to the enclosure; and a computing system or computer 30, the computer comprising a processor 32, a data storage unit 34, and a graphical user interface (GUI) 40.

The present disclosure makes reference to inventory items such as flight tools, but the inventory items 20 may further encompass all manner of single use or repetitive use items, including, for example: all manner of tools; paper products; perishable goods including foods; books; auto parts, computer parts, and all other kinds of parts; and any other items for which an inventory system is desired.

The locking mechanism 12 of the embodiment shown in FIG. 1A engages two enclosure doors 13, 14 to lock the enclosure. The locking mechanism may comprise any locking device that can be controlled by a computer including an electronic activator for activation of the locking device. The locking mechanism may employ pins, brackets, cams, magnets, wedges, springs, catches, and any other devices in various combinations to provide locking functionality suitable for a particular application. The access to the enclosure may be via hinged or sliding doors, drawers, or any other suitable access portal for an enclosure of any size.

The enclosure 10 and compartments 15 of the present disclosure may likewise encompass a wide range of enclosures that are suited to the inventory items involved. For example, where the inventory items are flight tools, the enclosure may be a toolbox wherein the compartments are drawers within the toolbox. Where the inventory items are perishable goods, the enclosure may be a refrigerated storage unit. Larger inventory items may apply to an enclosure that encompasses an entire building, wherein the compartments are rooms or may, in such instances, be regions within the enclosure.

The computing system or computer 30 is used to record data related to an inventory transaction and further controls the locking mechanism 12 that controls access to the enclosure 10. The computing system or computer may be contained within the enclosure, attached to the enclosure, or it may also be externally connected to the enclosure. The data to be recorded depends on the type of transaction, but generally includes time and date of the transaction and the identification of a user to whom the items will be assigned or from whom the item is being received. The user identification may be provided by card reader 36, which reads a user's identification card, or by a login code entered by the user via the GUI 40. The user identification card preferably includes a radio frequency identification (RFID) tag but alternatively may use a magnetic strip, bar code, or other form of identification.

In one embodiment, the recorded data also will include a location at which the item is used. This preferred feature aids inventory management where the inventory item, such as a tool, becomes misplaced and must later be found. This feature also may aid in cost accounting where the item is, for example, a part to be installed.

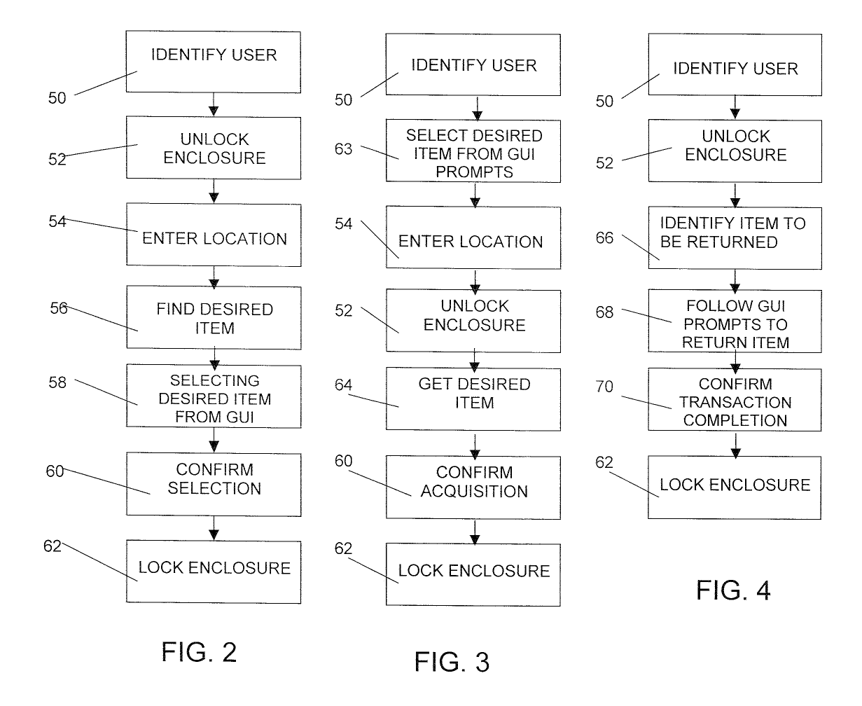

The operation of the computer is, in part, described in FIGS. 2-6, which outline various methods associated with the transactions governed by the inventory management system of the present disclosure. Referring to FIG. 2, the present disclosure provides a method for checking out an inventory item to and from an inventory management system to a user, comprising: identifying the user to the computer system 50, unlocking the enclosure 52, entering the destination where the item will be used into the computer system 54, finding the desired item within the enclosure 56, selecting the compartment where the desired item was found within the enclosure using the GUI and selecting the desired item from the graphical user interface 58, confirming the tool selection 60, and locking the enclosure 62.

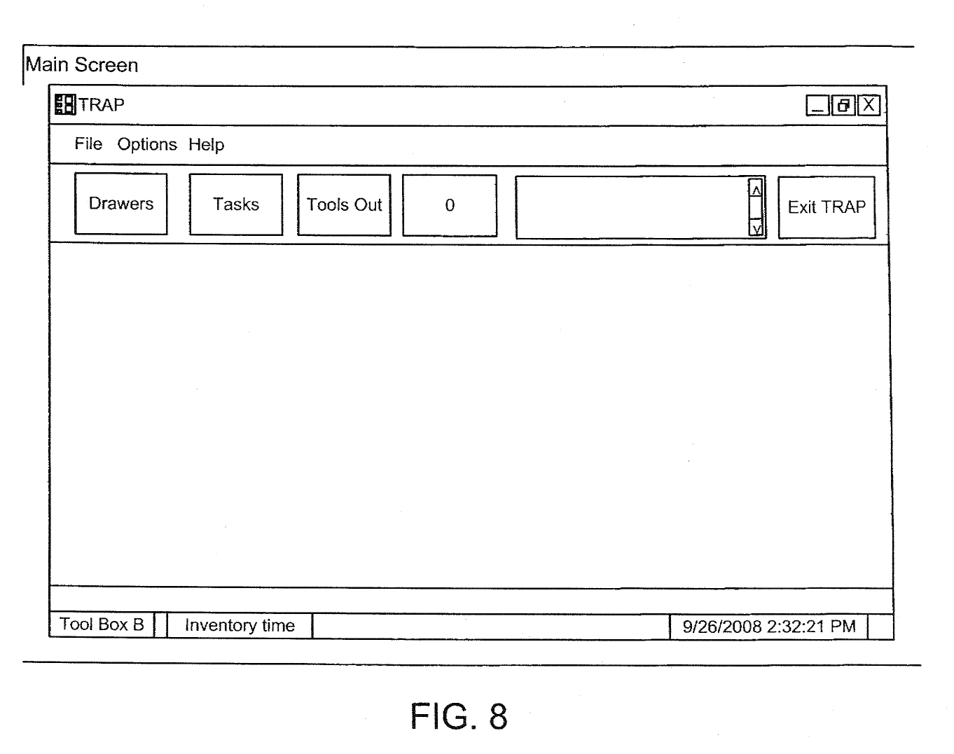

FIGS. 8-18 are illustrations of GUI screens where the some of the steps of the various procedures discussed herein are executed. These figures are from a preferred embodiment of the present disclosure related to a flight tool inventory management system employing a software program entitled Tool Report Access Program (TRAP).

As discussed above, the step of identifying the user may be performed in a number of different ways. Preferably, the computer will identify the user as the user swipes a proximity card having an RFID tag over that is read by a card reader. Alternatively, the user may have a card with a magnetic stripe or a bar code that is read by a card reader.

Other alternative ways to identify the user are also possible. The proximity badge and card reader of the embodiment described above may be replaced with a biometric scanner that identifies a user by, for example, fingerprint, eye recognition, voice recognition, or some other biometric measure. A less expensive, though less secure method, that would not require a proximity badge, involves assigning each authorized user a Personal Identification Number (PIN) to be entered into the computer identifying the user. Any of the methods discussed in the present disclosure may be used in combination to provide an alternative means of identification or to provide redundancy for increased security.

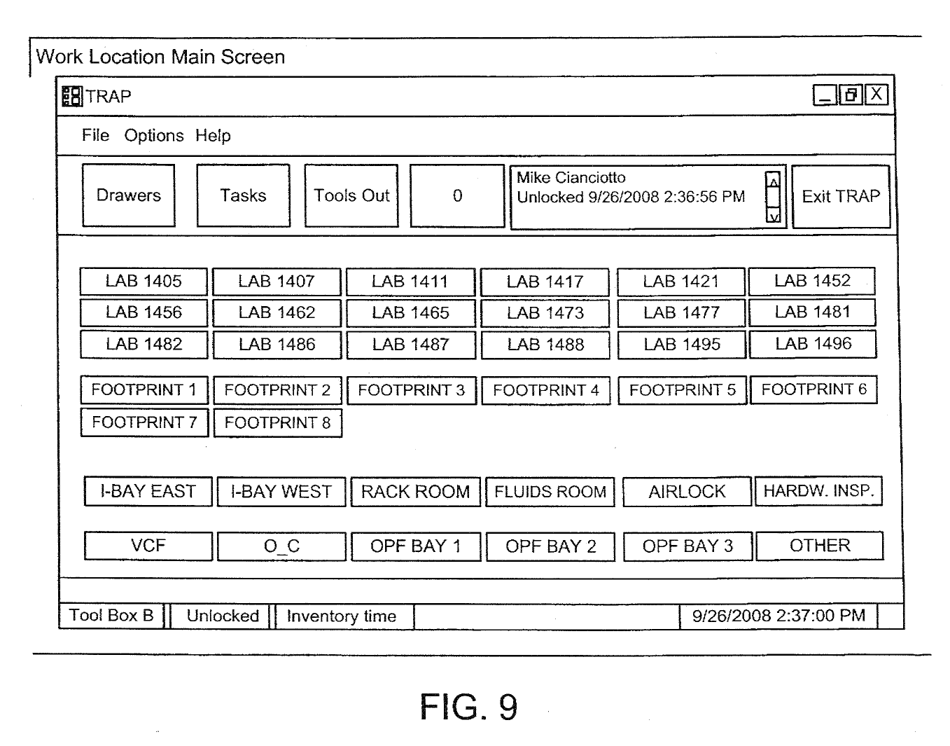

After the user is identified, the GUI will display a main screen that allows the user to select the task that will be performed. For example, a menu may be presented for selection of tasks such as item inventory, item checkout, item transfer and item return. This main screen may also be used to display some general information, such as the number of items checked out (See FIG. 8) and whether or not the enclosure is locked (See FIG. 9).

The user enters the location where the item will be used or installed. The computer prompts this information from the user via the GUI and the user then enters this information, which becomes part of the transaction record, along with the date and time of the transaction and the user identification. The GUI may display graphically the various locations where the item may be used, such as in FIG. 9.

The user then locates the desired item within the enclosure. The system may be configured to allow the user to search for the location of the item using the GUI. For example, the user may be prompted by displaying a graphical representation of the location within the enclosure where an item is stored. The GUI may prompt the user to select a compartment and may further prompt the user to select a physical area of the compartment. The GUI would then return the compartment and specific area of the compartment where the item will be found and whether or not the item is checked out. The GUI may also display a picture to help the user confirm the selection of the correct item.

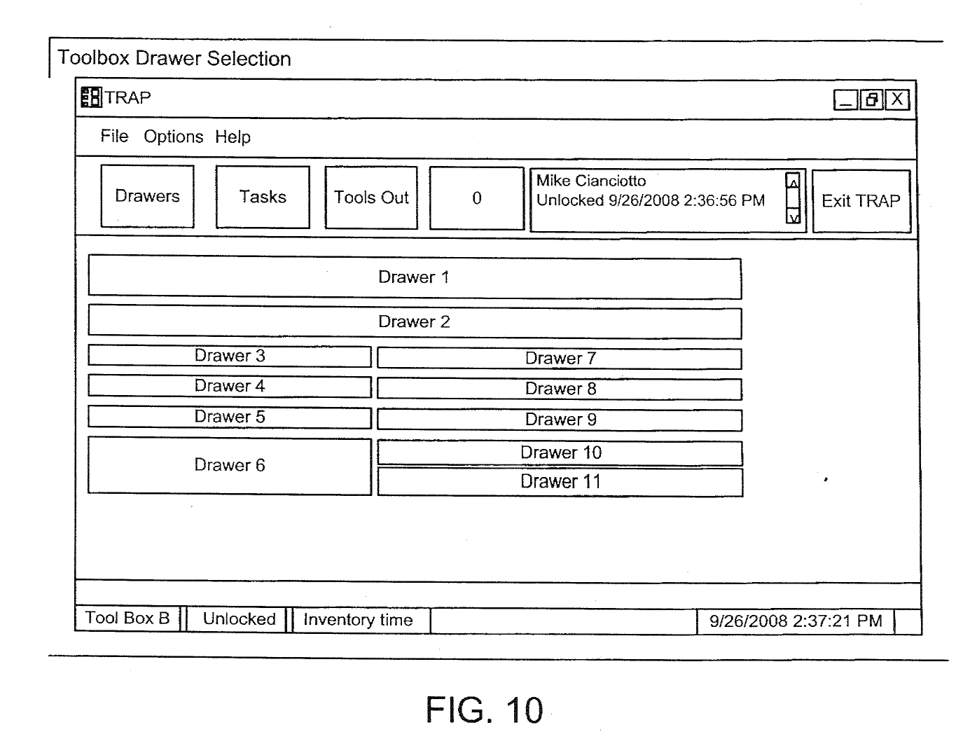

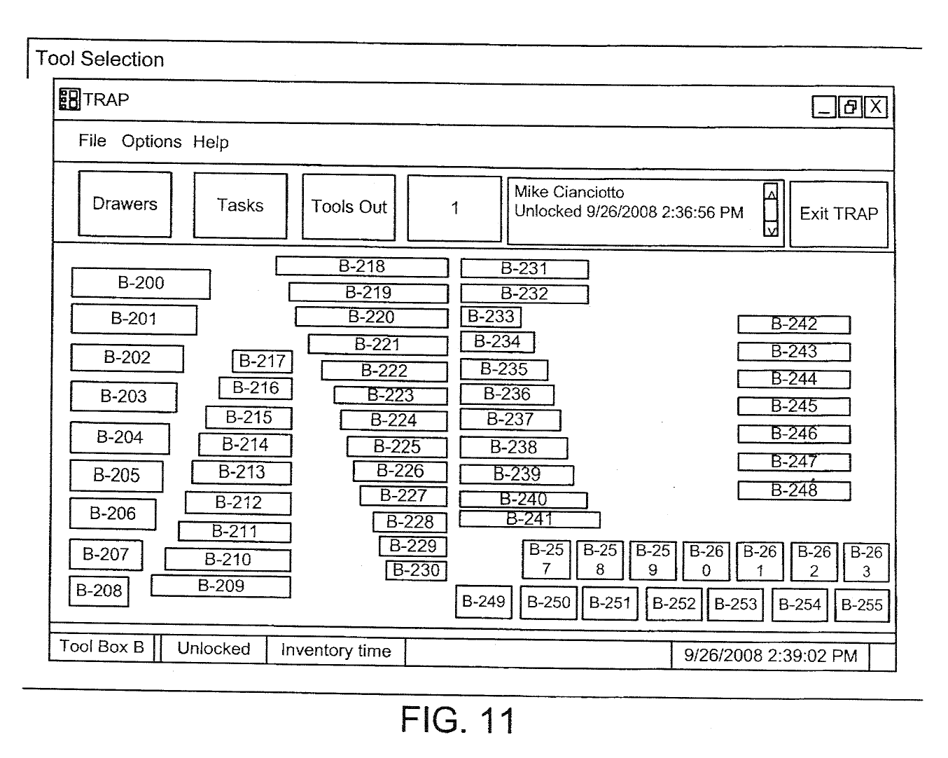

The user then identifies the desired item via the GUI. As noted supra, RFID tags used in prior art solutions commonly become separated from items such as tools during use making the transaction data unreliable and often incomplete. The method of the present disclosure addresses this problem by creating an intuitive item identification procedure. Preferably, this procedure includes selecting the compartment where the item is located on a GUI comprising a touch screen; selecting the area of the compartment where the item was found within the compartment, the area of the compartment being associated with a specific item or items; and confirming the selection of the desired item. FIGS. 10 and 11 show examples of GUI screens for the compartment selection and tool selection, respectively. For purposes of this disclosure, the GUI may also be defined as any visual interface wherein the user may exchange information and commands with the computer using other input devices, such as a mouse, keyboard, voice recognition system, or any other means. This could even include, for example, a set of discrete input buttons or switches.

Depending on the specific application or the configuration of the system, it may be desirable to unlock the locking mechanism at different points within the above-described method. For instance, the user may need to look through various compartments and inspect the item before they can select the item using the GUI. In these cases, the computer will send a signal to unlock the locking mechanism either once the user has been identified or after the user confirms the location where the item is to be used. Another embodiment requires the user to have the user card read a second time to lock the enclosure to end the transaction.

The computer also may supply voice prompts to aid the user in confirming the transaction steps. For instance, the computer may audibly confirm the location and/or tool selection during confirmation steps to help ensure that the transaction record is accurate.

Alternatively, where tighter control of inventory is necessary, the computer may require other parameters to be entered before the locking mechanism is released. For example, the user may be required to input the desired item into the computer via the graphic interface before the computer unlocks the enclosure. See FIG. 3. Note that the computer may prompt the user in selecting the desired item 63. The GUI may also show the user where within the enclosure the item will be found to simplify the step of getting the desired item 64. Also note that the tool selection and location entry may be submitted in a different order in this scenario.

Some applications may find it useful to restrict access to specific compartments by using a plurality of locking mechanisms, one for each compartment. These may be in lieu of or in addition to the locking mechanism for the enclosure. One instance where this may be useful is, for example, where a user has clearance to acquire items contained only a specific compartment or a limited number of compartments.

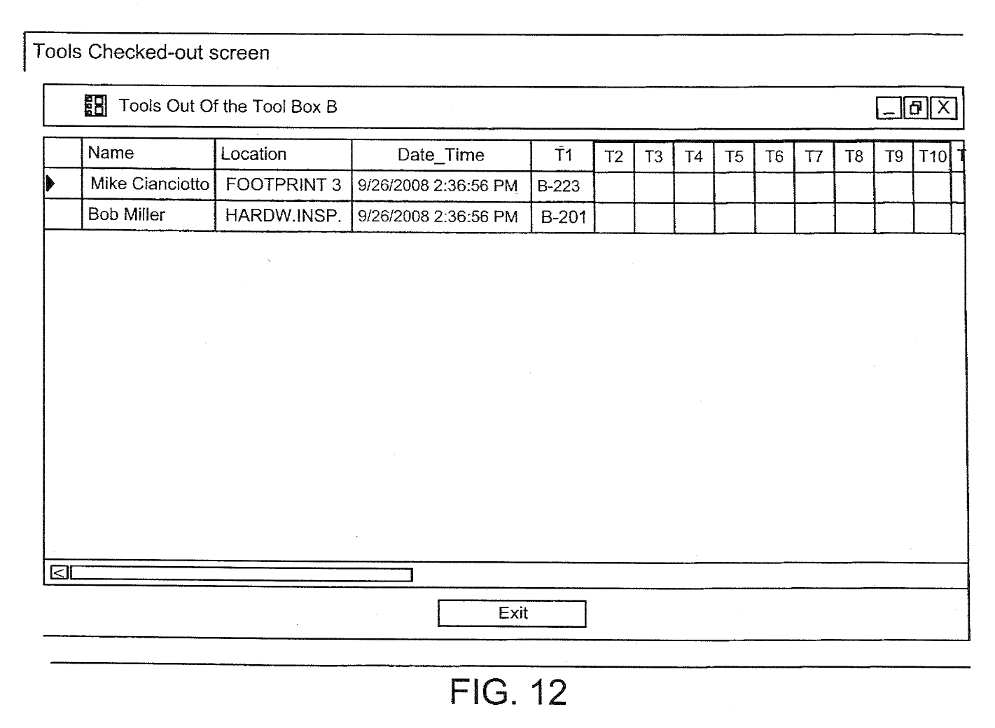

Referring to FIG. 4, the present disclosure further provides a method for inventorying the return of an item to the enclosure. This may be a tool that has been used or a single use item that was not used. In this method, the user is identified using any one of the systems described above, preferably a proximity card. The GUI then displays, either automatically or on command, the most recent transactions associated with the user. See, for example, FIG. 12. The computer may additionally provide an audible signal that relays the transaction data related to items that are checked out and the location where they were being used. The user then selects the transaction for the item that is being returned 66. Again, an audible confirmation of this selection may be conveyed by the computer.

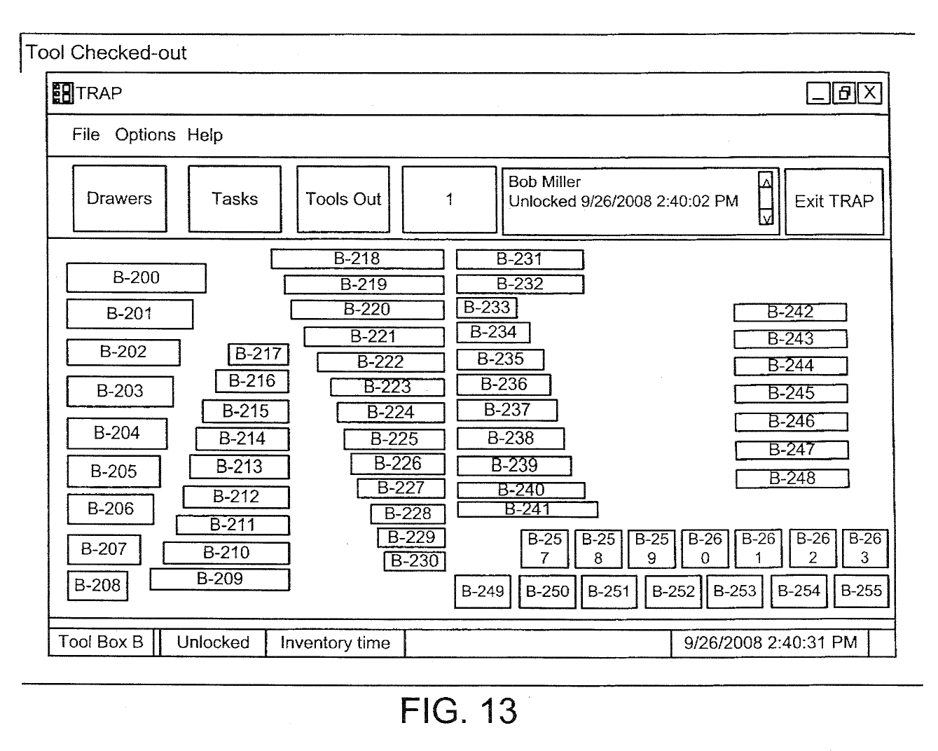

Upon selecting the transaction and the associated item, the computer may display the layout of the compartment where the item is to be returned via the GUI 68. Referring to FIG. 13, this screen shows which tools are checked out by the user and which tools are checked out by other users. In this example, the status of the various tools is differentiated by color. The GUI may prompt the user to return the item to a specified place within a particular compartment.

Depending on the application, the locking mechanism may unlock the enclosure when the user is identified 52 or when the item to be returned is identified.

Finally, once the item has been returned, the user confirms this transaction has been completed via the GUI 70, whereupon the enclosure is locked 62.

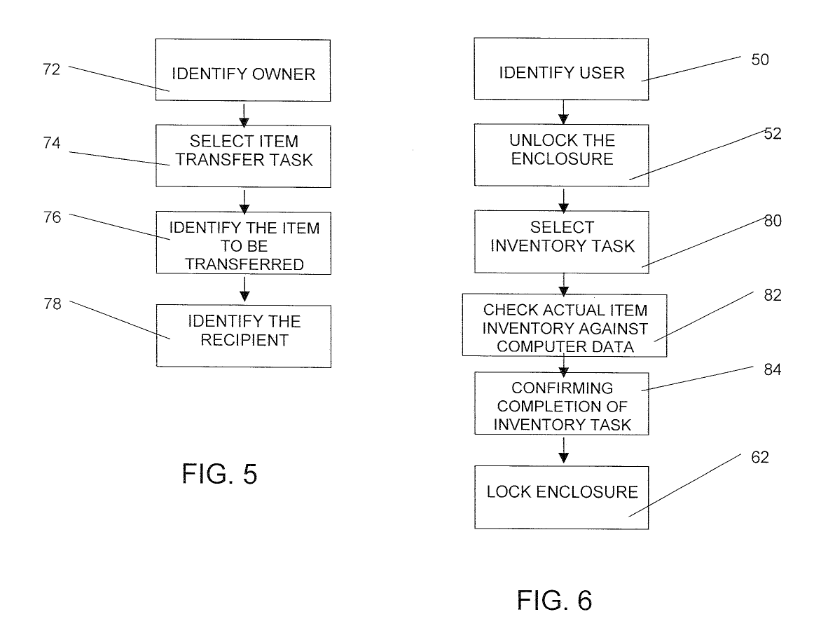

The present disclosure also provides a method for transferring an item from a current “holder” or “owner” (the user to whom the item has been checked out) to a new holder or “recipient” (the user that is accepting responsibility for the item) using the inventory management system described above. Referring to FIG. 5, the method comprises: identifying the owner 72; informing the computer that a transfer transaction is to be entered 74; confirming the item to be transferred 76; and identifying the recipient 78. The owner and recipient may be identified by any of the systems described above. Depending on the application, the enclosure may or may not unlock during this method. Alternatively, the recipient may further be required to confirm the location where the tool will be used.

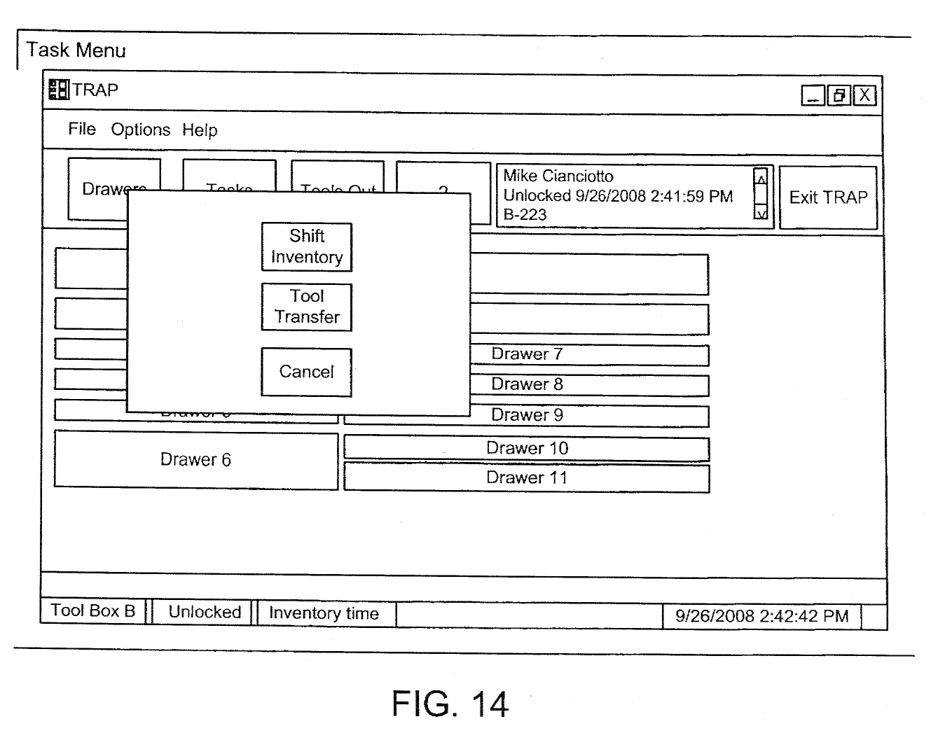

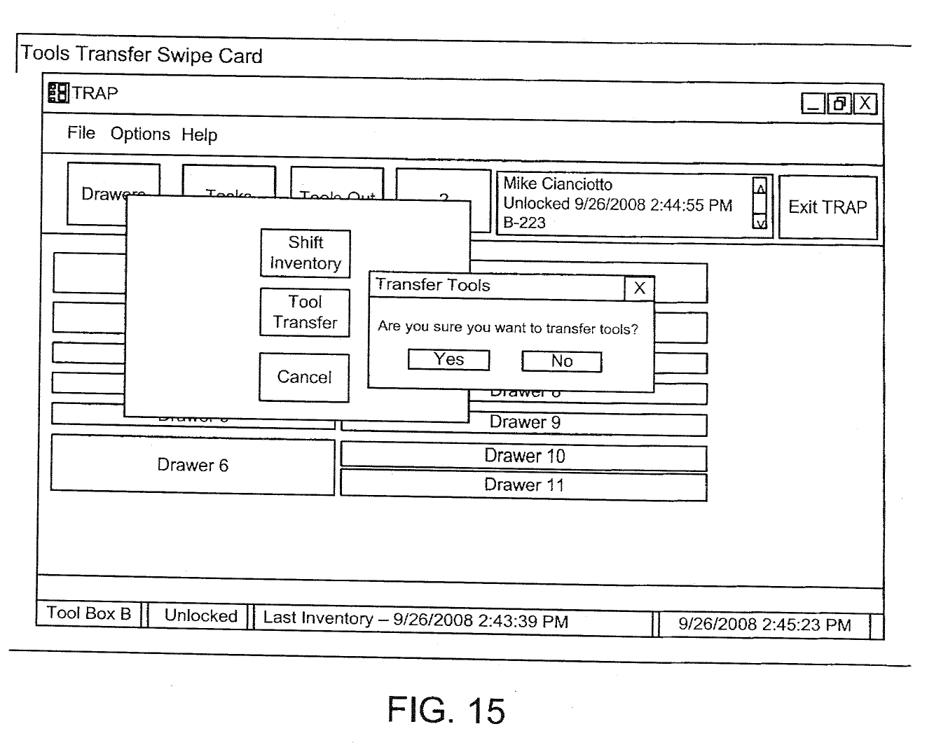

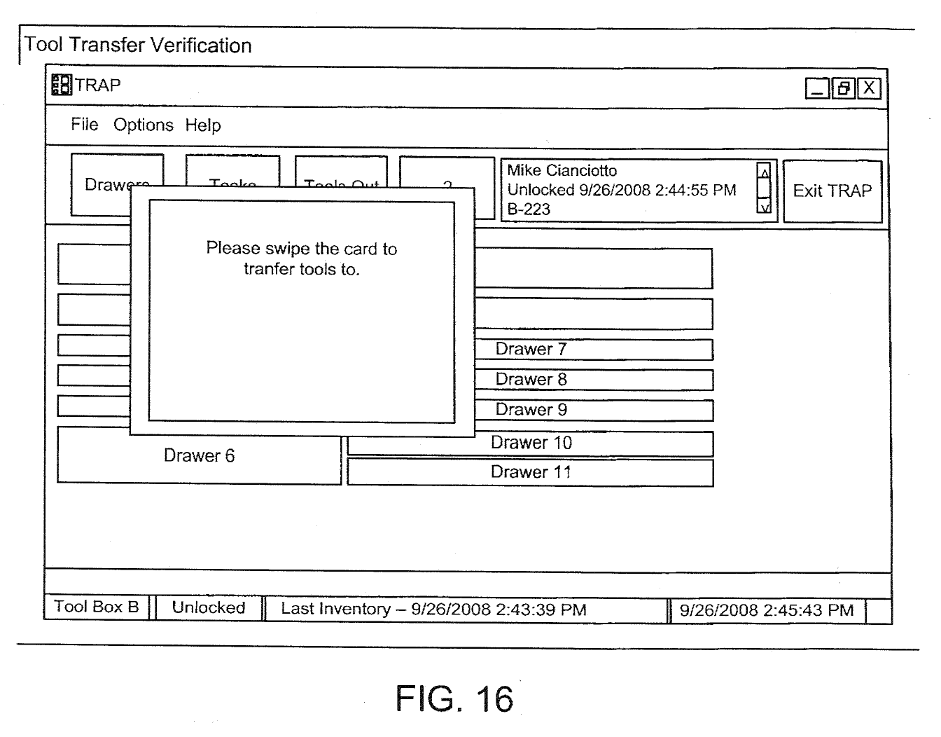

Preferably, the computer is informed of the transaction by selecting an “item transfer” button from a “tasks” menu on the GUI. See, for example, FIG. 14. The method may further include the steps of confirming that the owner wants to transfer the item to the recipient (See FIG. 15) and confirming that the correct item has been identified for transfer. In applications where the owner may have more than one item checked out, this may require that the owner select the item to be transferred from a list. Alternatively, the owner may wish to transfer all items checked out to them. Once the item has been identified, the GUI may prompt the owner to physically transfer the item or items. See FIG. 16. Each of these steps may be accompanied by a confirmation via the GUI and an audible description from the computer. Once the item has been transferred, the recipient is identified to complete the transaction.

The inventory management system of the present disclosure also may incorporate a method for checking the inventory against the records in the data storage of the computer. Referring to FIG. 6, this method comprises the steps of: identifying the user; informing the computer that an inventory task is to be performed 80; checking the contents of the various compartments against the transaction records 82; and confirming that the task has been completed 84. As with the methods above, the user may be identified 50 by various means, preferably a proximity card. The enclosure should unlock 52 either when the user is identified or when the inventory task is selected. The enclosure should lock 62 upon confirming that the transaction has been completed.

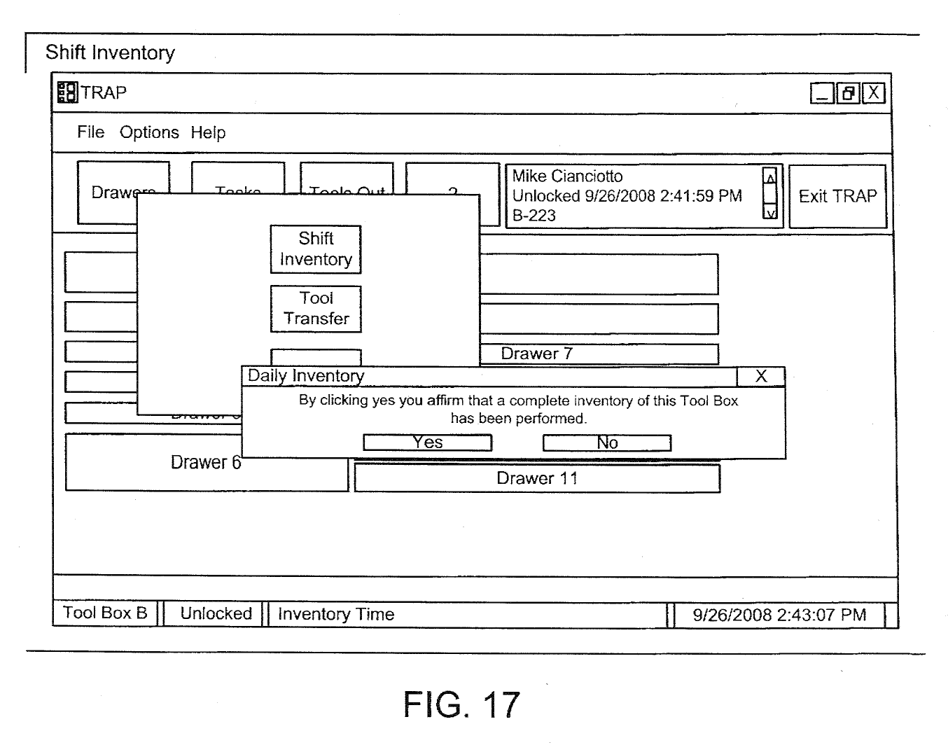

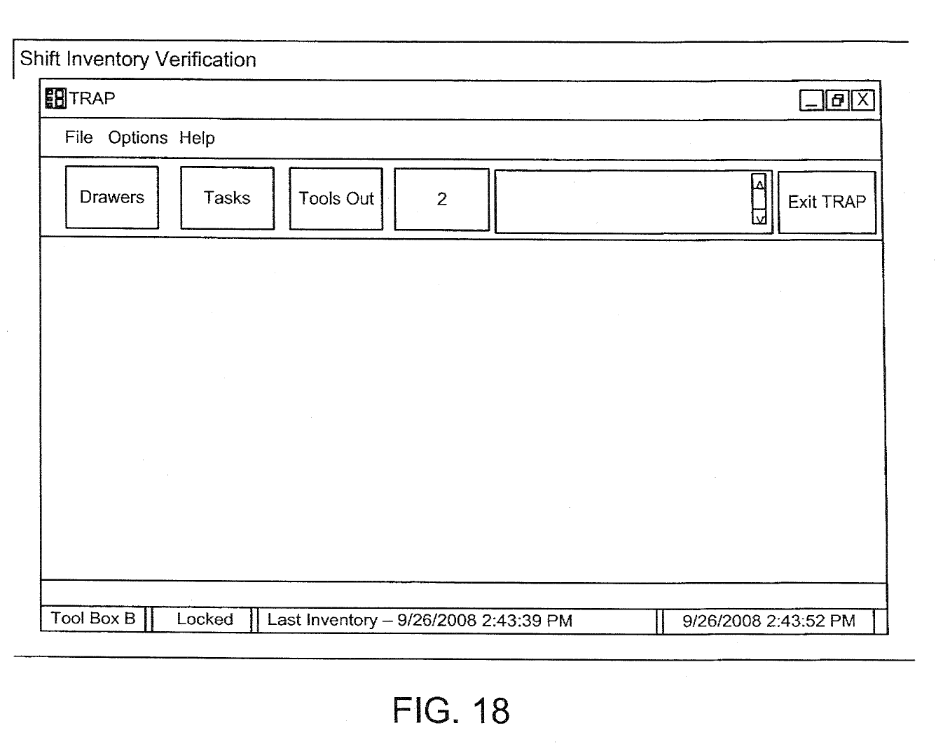

Preferably, the computer is informed of the inventory task by selecting a “inventory” button from a “tasks” menu on the GUI. See, for example, FIG. 14. The user may then use the GUI to verify that the actual contents of each compartment match the records on the computer. The user also may check items in or out during the inventory task. Any discrepancies between the actual contents of the compartment and the records may be entered by the user and a report may be generated. Some applications require that the discrepancy be resolved right away. The user then confirms that the inventory task has been completed. See FIG. 17. The time of the last inventory is displayed on the GUI. See FIG. 18. Alternatively, the inventory may be conducted for each compartment individually. This alternative is particularly useful for very large inventory systems.

In some applications, there may be varying levels of authorization for users. For example, some applications may require that only certain users be authorized to take inventory of the system. There may be other tasks that should only be performed by a supervisor. For purposes of this disclosure, a supervisor is meant to include any user that is given a higher level of authorization whereby the user can perform tasks on behalf of other users. This may simplify situations where the “owner” of an item is injured and leaves the facility without being able to return the item to the enclosure. The supervisor may return that item to the enclosure or transfer that item to another user. The supervisor must either identify the user or the item to perform the transaction. In some instances, the supervisor will need to identify both.

The supervisor, and perhaps additional users, also may have the ability to search the database of records on the data storage device to track a particular item or user. The program may generate a report on the use of a particular item and the users and locations associated with that use, or may be used to generate a report on the activities of a particular user. This could be useful for determining which tools are either infrequently used or are no longer used. The program also may generate a list of tools or items expected to be needed to perform a particular maintenance task, prompting the user to withdraw all the tools that would be needed to complete the task, and thus save the user time and inconvenience of having to return to the tool enclosure for a forgotten tool.

Another alternative embodiment of the present disclosure includes a scanning mechanism for each of the various compartments of the enclosure, whereby the scanning mechanism periodically scans each compartment periodically to automatically perform an inventory check. The scanning mechanism may be, for example, an optical sensor or array of optical sensors for which the computer can be programmed to compare data between scans.

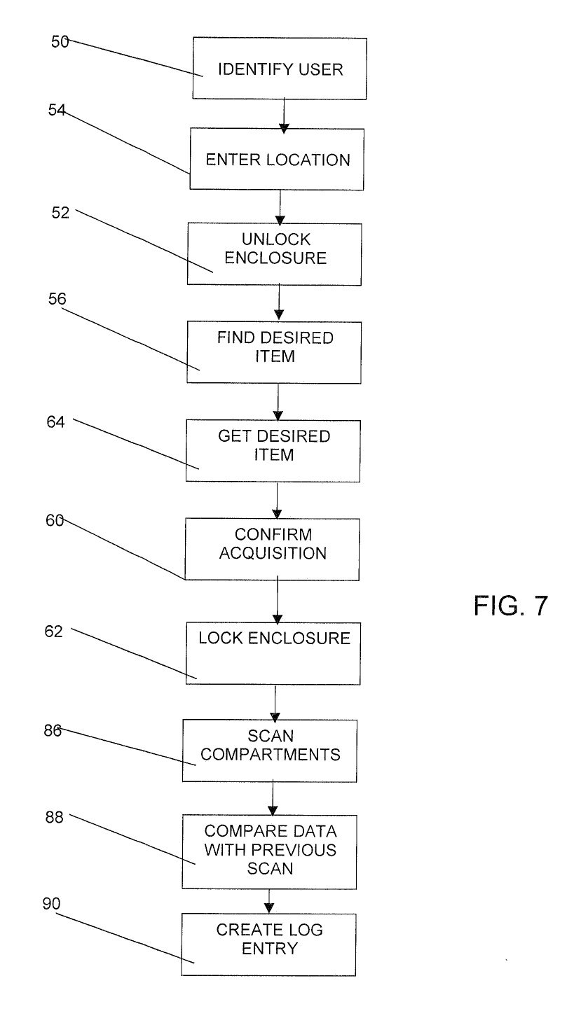

The scanning mechanism may further be implemented to simplify the methods of the present invention. For example, FIG. 7 displays a method for checking out an item from the inventory management system of the present disclosure employing a scanning mechanism, comprising: identifying the user 50, entering the location where the item will be used 54, unlocking the enclosure 52, finding the desired item 56, taking the desired item 64, confirming the acquisition of the item 60, locking the enclosure 62, scanning the compartments 86, comparing the data with the previous scan 88, and creating the log entry based on that comparison 90. Note that this alternative method requires much less user input when compared with the methods displayed in FIGS. 2 and 3. For instance, instead of requiring the user to follow the prompts provided by the GUI to confirm which item was acquired by the user, the computer determines which item was acquired by analyzing the data from the scanning mechanism which activates upon locking the enclosure.

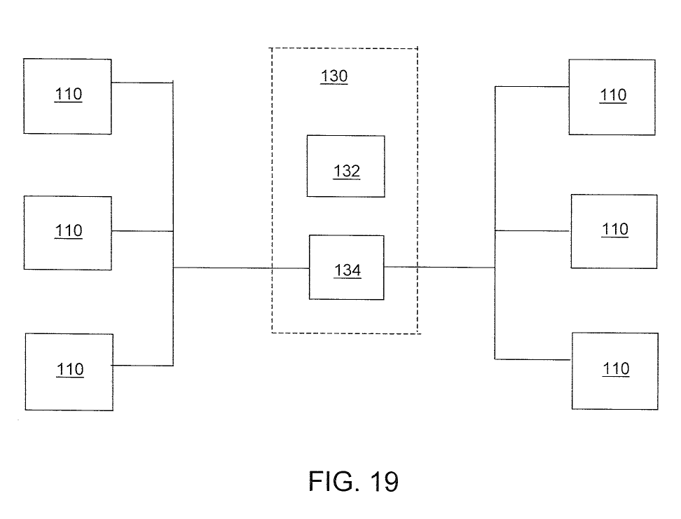

Another feature of the present disclosure provides that the computer of the inventory management system is networked with a centralized database. See FIG. 19. The central database 134 may function as a data storage unit for several enclosures 110 or a redundant database. The central database is connected to a central computer 130 which would provide central access to information on items and reports via user interface 132.

The system and methods of the present disclosure increase the reliability of the inventory management over prior art systems by withholding access from unauthorized users, providing complete records including the location where an item is being used and the time of the transaction, and reducing the amount of time required for transactions such as item transfer and inventory. For example, using previous methods, item transfer times were on the order of up to 5 to 10 minutes. The present disclosure contains a method whereby an item transfer takes place in under 15 seconds. Other methods also reduced time significantly from previous methods, usually 50% or more.

The present disclosure further provides increased accountability of the various users over the prior art systems and methods. As applied to a flight toolbox, it is expected that this increased accountability and reliability will reduce potential foreign object debris (FOD) issues that affect crew safety. Thus, the system and methods of the present disclosure support electronic identification for area access, equipment checkout/control, and personnel identification while reducing risk of FOD and providing a real-time assessment tool for program assets.

It should be emphasized that the above-described embodiments of the present disclosure, particularly, any “preferred” embodiments, are merely possible examples of implementations, merely set forth for a clear understanding of the principles of the present disclosure. Many variations and modifications may be made to the above-described embodiments without departing substantially from the spirit and principles of the disclosure. For example, in lieu of a location where the item is being used, the present disclosure may require a specific task or even a job number with which the item will be associated. All such modifications and variations are intended to be included herein within the scope of this disclosure and protected by the following claims.

What is claimed is:

1. An inventory management system for tracking the use of inventory items, comprising:
an enclosure for containing a plurality of inventory items;
a locking mechanism for preventing unauthorized access of the enclosure; and
a computing system for controlling the locking mechanism and recording a transaction, wherein the computing system further comprises a processor, a data storage unit, and a graphical user interface.

2. The system of claim 1, wherein the enclosure further comprises a plurality of compartments, each of which contains a plurality of inventory items.

3. The system of claim 2, wherein each of the compartments includes a scanning mechanism capable of sensing the presence of the inventory items.

4. The system of claim 1, further comprising a card reader for identifying a user.

5. The system of claim 1, wherein the computing system is configured to provide a user with prompts via the graphical user interface that allow the user to input the location where an item will be used.

6. The system of claim 1, wherein the computing system is configured to provide a user with prompts via the graphical user interface that allow the user to select one of a number of tasks from a menu, the tasks including item inventory, item checkout, item transfer, and item return.

7. The system of claim 6, wherein the prompts display a graphical representation of the location within the enclosure where an item is stored.

8. The system of claim 1, further comprising a plurality of enclosures, each enclosure including a locking mechanism and a computing system, wherein the each of the computing systems is networked to a central computer database.

9. A method for operating an inventory management system, comprising the steps of:
placing at least one inventory item in at least one compartment within an enclosure;
providing restricted access to the enclosure by use of a locking mechanism; and
controlling the locking mechanism with a computing system comprising a processor, a data storage device, and a graphical user interface;
wherein access to the enclosure is restricted to authorized users that are identified by the computing system; and
wherein the method further comprises at least one of the following steps:
(a) assigning a desired item to an authorized user, and prompting the user to input a location where the desired item will be used;
(b) returning an item from a user to whom the item has been assigned;
(c) transferring an item from a first user to whom an item has been assigned to a second user; and
(d) taking inventory of the items in the enclosure by using the graphical user interface to verify the actual inventory against transaction data recorded on the data storage device.

10. The method of claim 9, wherein step (a) includes the steps of:
identifying the user;
unlocking the enclosure;
entering information via the graphical user interface regarding the location where the desired item will be used;
finding the desired item within the enclosure;
following a series of prompts to specify the desired item using the graphical user interface;
confirming the selection of the desired item; and
locking the enclosure.

11. The method of claim 10, wherein the series of prompts from the graphical user interface include a prompt allowing the user to select the compartment where the desired item was found and a prompt allowing the user to select the physical area of the compartment where the desired item was found.

12. The method of claim 10, wherein the step of unlocking the enclosure occurs after the step of entering information via the graphical user interface from a user regarding the location where the desired item will be used.

13. The method of claim 9, wherein step (a) comprises the steps of:
identifying the user;
following prompts to specify the desired item using the graphical user interface;
entering information via the graphical user interface from a user regarding the location where the desired item will be used;
unlocking the enclosure;
finding the desired item within the enclosure;
confirming the selection of the desired item; and
locking the enclosure.

14. The method of claim 9, wherein step (b) includes the steps of:
identifying the user;
unlocking the enclosure
identifying the item to be returned
following prompts from the graphical user interface to return the item to a specified place within the at least one compartment of the enclosure; and
confirming that the item has been returned.

15. The method of claim 14, wherein the prompts from the graphical user interface include a screen showing the layout of the compartment where the item is to be returned.

16. The method of claim 14, wherein the step of unlocking the enclosure occurs after the step of identifying the item to be returned.

17. The method of claim 9, wherein step (c) comprises the steps of:
identifying the first user;
using the graphical user interface to select an item transfer task;
confirming the item to be transferred; and
identifying the second user.

18. The method of claim 9, wherein step (d) comprises the steps of:
identifying the user;
unlocking the enclosure;
using the graphical user interface to select an inventory task;
checking actual inventory of items against transaction data on the data storage device using the graphical user interface;
confirming completion of the inventory task; and
locking the enclosure.

19. The method of claim 18, wherein the step of unlocking the enclosure occurs after the step of using the graphical user interface to select an inventory task.

20. The method of claim 9, wherein the user is identified by a method from the group consisting of: swiping a user identification card with a radio frequency identification tag over a card reader; swiping a user identification card with a magnetic strips through a card reader; swiping a user identification card with a bar code over a bar code reader; entering a user code using the graphical user interface; and using a biometric reader.
